(19) United States
(12) Patent Application Publication
(10) Pub. No.: US 2010/0063702 A1
(43) Pub. Date: Mar. 11, 2010

(54) SYSTEM AND A METHOD FOR STABILISING A VEHICLE COMBINATION

(75) Inventors: Mats Sabelström, Billdal (SE); Lena Larsson, Vastra Frolunda (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/995,035

(22) PCT Filed: Jul. 6, 2006
(86) PCT No.: PCT/SE06/00849

§ 371 Date: Jan. 8, 2008

(30) Foreign Application Priority Data
Jul. 11, 2005 (SE) 0501657-1

(51) Int. Cl. B60T 7/20

(52) U.S. Cl. 701/70

(57) ABSTRACT

In a system and a method of stabilizing a vehicle combination of a towing vehicle and a trailer or a semi-trailer, wherein a trailer brake system on the trailer or semi-trailer which may be operated together with the a vehicle brake system on the towing vehicle as well as independent from said vehicle brake system, the system and method includes: detecting at least one signal corresponding to at least one driving condition; computing the detected at least one signal corresponding to said at least one driving condition and comparing the at least one detected signal with a corresponding predetermined values representing a critical driving condition; allowing independent operation of the trailer brake system in response to a detected critical driving condition; and automatically operating the trailer brake system in response to the activation means by applying temporary braking actions on the trailer. Hereby, a proactive stabilising trailer brake system, also known as stretch-braking, is provided.

### BACKGROUND AND SUMMARY

The present invention relates to a system and a method for stabilising a vehicle combination comprising a towing motor vehicle and a towed vehicle. The towed vehicle comprises one trailer or a combination of trailers. A trailer can either be a drawbar trailer, also named full trailer, or a semi-trailer.

From EP 0 941 905 a system of such kind is known. In this system, a tractor vehicle is provided with a steering wheel sensor, a yaw rate sensor, a transverse acceleration sensor and/or an inflection angle sensor detecting the angle between the longitudinal axis of the tractor vehicle and the longitudinal axis of the trailer. At the tractor/trailer interface, braking pressure for braking the trailer wheels may be provided in response to the sensors in the event of the presence of a stability-critical driving status is detected.

In U.S. Pat. No. 6,450,019 B1 another apparatus and method for stabilising a vehicle combination is described, wherein the inflection angle between the longitudinal axis of the tractor vehicle and the longitudinal axis of the trailer is determined and a comparison is performed as a function of the inflection angle variable and a comparison variable. An actuator arrangement is associated with the trailer with which a brake pressure can be established at one or more of the wheels of the trailer to re-establish a stability of the tractor/trailer combination.

These known systems are automatically re-establishing a stability if the tractor/trailer combination has become unstable, so-called “stretch braking” Previously, a manually operated separate trailer brake was installed, allowing the driver to use auxiliary trailer braking on the vehicle combination when releasing the accelerator pedal or when driving on slippery road conditions. But this caused a considerable wear on the trailer brakes, as the trailer brake was often used to decelerate the entire road train. Therefore such systems were abandoned and made illegal due to the adverse effect on road safety as the result of the manual trailer braking was that many trailers were driving around with worn brakes. The automatic systems are considered inadequate as they are quite complicated and expensive. In particular, as the tractors and trailers grow bigger in size to transport an increasing payload, the problem of instability of the vehicle combination will increase and with the known systems, the wear of the trailer brakes will also increase.

On this background, it is desirable to provide a stabilising method and system for a vehicle combination providing an improved stability of the vehicle combination.

In an aspect of a method and a system for stabilising a vehicle combination of a towing vehicle, such as a tractor or a truck, and a towed vehicle, such as at least one trailer or semi-trailer, the system includes: a trailer brake system on the towed vehicle which may be operated together with a vehicle brake system on the towing vehicle as well as independent from said vehicle brake system; means for detecting at least one signal corresponding to at least one driving condition; means for computing the detected at least one signal corresponding to said at least one driving condition and comparing the at least one detected signal with a corresponding predetermined values representing a critical driving condition; activation means for allowing independent operation of the trailer brake system in response to a detected critical driving condition; and means for automatically operating the trailer brake system in response to the activation means by applying temporary braking actions on the towed vehicle.

By an aspect of the present invention, a proactive stabilising trailer brake system is provided. Rather than sensing the actual relative position of the towing vehicle and trailer in the vehicle combination, the driving conditions are detected, and if the conditions are considered to be critical, e.g. a steep downhill road inclination, risk of slippery road conditions due to the ambient temperature, the trailer brake system can be activated. Hereby, the system can be used as a proactive system. The stabilising action can be defined as ESP (Electronic Stability Programme) interventions that allow temporary trailer braking actions. These actions preferably comprise short repeated trailer brake actuations that are strong enough to significantly affect the vehicle combination but not strong enough to cause significant trailer brake wear, fading or glazing problems. The computing means decide if a critical driving condition is detected and if so, allows the operating means (ESP) to perform automatic trailer braking actions. Hereby, a proactive stretch braking system for stabilising is achieved that can be defined as ESP interventions that (legally) allows temporary trailer braking actions. This is in particular advantageous for larger vehicle combinations which may be less stabile in some driving conditions.

The driving condition detection preferably includes detecting one or more of the following driving conditions:

Ambient temperature. If a risk of ice or snow on the road is present due to the ambient temperature, the system is informed of this.

Road inclination. The computing could be adapted in such a manner that the operation means are only allowed activation if the inclination angle is a downhill inclination above a certain angle or percentage.

Steering wheel angle. In order to avoid the separate trailer braking action to influence the driving path, a limitation in the activation of the operating means may be defined which is dependent on the steering wheel position.

Vehicle combination weight. In order to apply a suitable amount of temporary trailer braking, it would be advantageous for the system to have information of the vehicle combination weight.

Auxiliary braking of the tractor vehicle with a braking torque above a predefined limit, such as auxiliary brake usage, such as engine brake and/or retarder. This braking torque limit could also be temperature dependent.

Vehicle combination speed. A limit to the minimum and maximum speed for the allowance of the trailer brake system could be defined to avoid adversely affecting the stability of the vehicle combination at high speed and to avoid constrains in parking manoeuvres at low or reverse speed.

Braking balance between towing vehicle and trailer. This information can be obtained from the CFC (Coupling Force Control) function of the towing vehicle. An underbraked trailer, i.e. a trailer that is braked less than required, can cause a “jack-knife” situation. This situation would give a signal asking for a more powerful brake actuation of the trailer brake. An overbraked trailer, i.e. a trailer that is braked more than required, can cause a “trailer swing-out” situation. This situation would give a signal asking for less or no brake actuation of the trailer brake.

The computing of the detected signals determines if a critical driving condition is present and alerts the activation means. The independent operation of the trailer brake system may be automatically activated in response to the detected critical driving condition. Hereby, the driver does not need to activate the auxiliary trailer brake system. Alternatively, the independent operation of the trailer brake system may be activated by a driver operated activation switch in response to an indicator triggered by the detected critical driving condition. This indicator may be a audio, visual or audiovisual indicator in the driver compartment of the vehicle. If the driver must allow the ESP of activating the auxiliary trailer brake system, the driver can actively also decide not to do so, e.g. if the vehicle combination is reversed e.g. for parking or loading or unloading. The indicator and the activation switch may be integrated in a multiple function panel or provided as separate indicator lamps and switches.

### BRIEF DESCRIPTION OF THE DRAWINGS

In the following, the invention is described in more detail with reference to the drawings, in which:

FIG. 1 is a schematic view of a braking system according to the invention on a first vehicle combination;

FIG. 2 is a schematic view of a braking system according to the invention on a second vehicle combination;

FIG. 3 is a schematic illustration of the system according to the invention; and

FIG. 4 is a diagram showing the auxiliary trailer braking actuations according to the invention.

### DETAILED DESCRIPTION

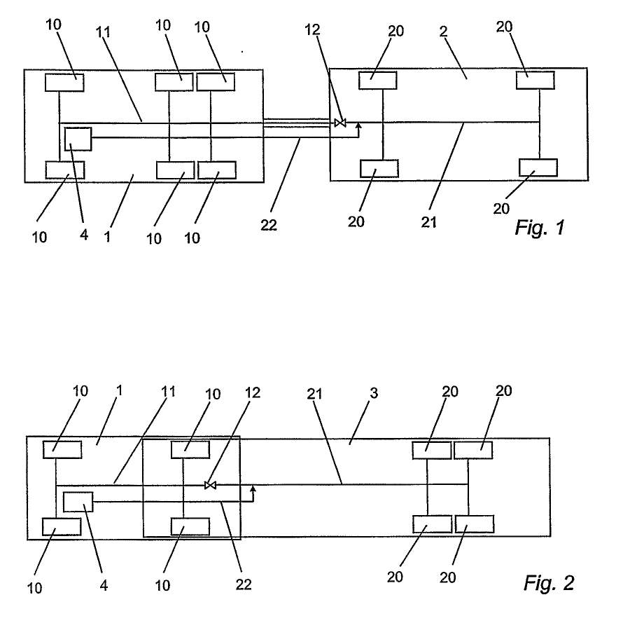

In FIG. 1, a first embodiment of the invention is shown, wherein the vehicle combination is a truck 1 with a draw bar trailer 2. The truck 1 has a braking system 11 for braking the wheels 10 on the tractor 1. Similarly, the trailer 2 is provided with a braking system 21 for braking the trailer wheels 20. The truck braking system 11 and the trailer braking system 21 are connected by a suitable coupling arrangement 12. An auxiliary trailer braking actuation arrangement 4 is provided which via a communication path 22 is connected to the trailer braking system 21. This communication path may be an electrical cable, a pneumatic or a hydraulic flow path.

In FIG. 2, a second embodiment of the invention is shown, wherein the vehicle combination is a tractor 1 with a semi-trailer 3 mounted thereon. The tractor 1 has a braking system 11 for braking the wheels 10 on the tractor 1. Similarly, the semitrailer 3 is provided with a braking system 21 for braking the trailer wheels 20. The tractor braking system 11 and the trailer braking system 21 are connected by a suitable coupling arrangement 12. An auxiliary trailer braking actuation arrangement or operation means 4 is provided which via a communication path 22 is connected to the trailer braking system 21. This communication path may be an electrical cable, a pneumatic or a hydraulic flow path.

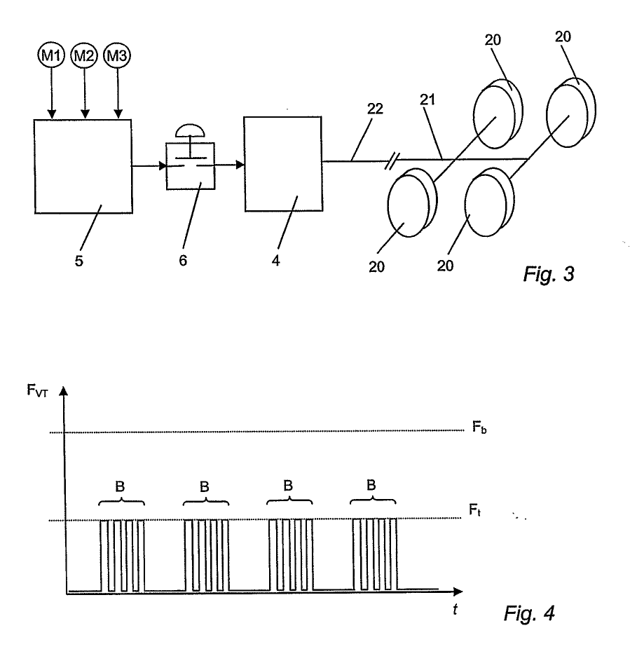

The system according to the invention is illustrated schematically in FIG. 3. A series of measurements M1, M2, M3 are fed to computing means 5 which determines if one or more of the measurements exceed a predetermined value, or a combination of the measurements exceed a threshold value representing a potentially critical road condition. If a potentially critical road condition is found present, the computing unit 5 allows switching means 6 to be operated, either manually or the computing unit switches on the switching means 6 automatically. The switching means 6 when switched on allows the ESP operation means 4 to perform separate braking actions B (see FIG. 4) in the trailer brake system 21 by feeding brake impulses through the communication path 22 to the trailer brake system 21 for activating the brakes on the trailer wheels 20.

The measurements that are detected and fed to the computing unit 5 may be one or more measurements relating to parameters which may influence the driving condition of the vehicle combination.

In the following are listed some relevant parameters influencing the driving conditions, partly due to road conditions subjected to the vehicle combination, and that may determine the activation of the operation means 4 for allowing auxiliary trailer braking to take place. The parameters may be:

Ambient Temperature.

If a risk of ice or snow on the road is present due to the ambient temperature, the system is informed of this and if the temperature is below a predetermined limit the system may be allowed activation. A temperature below this threshold limit could itself alone cause the ESP operation means 4 to be allowed, or such allowability could be made dependent on other measurements as well.

Road Inclination.

The computing could be adapted in such a manner that the operation means 4 are only allowed activation if the inclination angle is a downhill inclination above a certain angle or percentage.

Steering Wheel Angle.

In order to avoid the separate trailer braking action to influence the driving path, a limitation in the activation of the operating means may be defined which is dependent on the steering wheel position.

Vehicle Combination Weight.

In order to apply a suitable amount of temporary trailer braking, it would be advantageous for the system to have information of the vehicle combination weight.

Auxiliary Braking/Deceleration.

Auxiliary braking of the tractor vehicle with a braking torque above a predefined limit, such as auxiliary brake usage, such as engine brake and/or retarder, may be detected by measuring the acceleration and in particular the deceleration. This braking torque limit could also be temperature dependent or dependent on other parameters in order to allow for activation of the ESP operation means 4.

Vehicle Combination Speed.

A limit to the minimum and maximum speed for the allowance of the trailer brake system could be defined to avoid adversely affecting the stability of the vehicle combination at high speed and to avoid constrains in parking manoeuvres at low or reverse speed.

Braking Balance Between Towing Vehicle and Trailer.

This information can be obtained from the CFC (Coupling Force Control) function of the towing vehicle. If the ratio between the braking torque of the towing vehicle and the braking torque of the trailer is unbalanced, the vehicle combination may be unstable. The ratio of the brake torque should then preferably be adjusted. An underbraked trailer, i.e. a trailer that is braked less than required, can cause a “jack-knife” situation. This situation would create a signal asking for a more powerful brake actuation of the trailer brake. An overbraked trailer, i.e. a trailer that is braked more than required, can cause a “trailer swing-out” situation. This situation would create a signal asking for less or no brake actuation of the trailer brake.

Measurements of many of these relevant parameters are already made in most electronic systems installed in trucks and tractors. Therefore, the system according to the invention is easy to implement. The system may be implemented during the design and manufacture of tractors or mounted subsequently on tractors, trucks and the like.

In the diagram in FIG. 4 is shown the braking force FVT as a function of time t. As shown in the diagram, the braking actuations B comprise a series of repetitive brake impulses of a brake force level Ft which is strong enough to significantly affect the vehicle combination but not strong enough to cause trailer brake wear, fading or glazing problems. A braking action actuated in order to reduce speed of the vehicle combination and applied to both the tractor and the trailer is indicated by the dotted line Fb indicating that this brake force is higher than the proactive stabilising trailer brake actions.

By the invention, it is realised that the system may be applied to braking system that are both pneumatically, hydraulically or electrically operated.

In a further embodiment, a vehicle combination with a towing vehicle and two trailers is stabilised by the inventive system. The vehicle combination may e.g. comprise a tractor with a semi-trailer and an extra trailer coupled to the semi-trailer. This combination is used to make up for different length requirements in different states or regions. Another possible combination is a truck with two short trailers. In this embodiment, the system is adapted to start the braking actuation on the rearmost trailer when a critical driving condition is detected, in order to stabilise the vehicle combination. In this embodiment, it is possible to let the rearmost trailer brake operate independently, and also to let the front trailer brake operate independently of the vehicle brake but only when the rearmost trailer brake is actuated. In this way, the vehicle combination is stabilised from the rear of the combination.

Above, the invention is described with reference to some preferred embodiments. However, it is realised that other embodiments may be performed without departing from the scope of protection as defined by the accompanying claims.

1. A system for stabilising a vehicle combination comprising a towing vehicle and a towed vehicle, the system including:
a trailer brake system on the towed vehicle which may be operated together with a vehicle brake system on the towing vehicle as well as independent from said vehicle brake system;
means for detecting at least one signal corresponding to at least one driving condition comprising a braking balance between the towing vehicle and the towed vehicle;
means for computing the at least one detected signal and comparing the at least one detected signal with a corresponding predetermined value representing a potentially critical driving condition;
activation means for allowing independent operation of the trailer brake system in response to a detected potentially critical driving condition; and
means for automatically operating the trailer brake system in response to the activation means by applying temporary braking actions on the towed vehicle so as to achieve a proactive stabilization of the vehicle combination.

2. A system according to claim 1, wherein the detection means includes detecting a steering wheel angle.

3. A system according to claim 1, wherein the detection means includes detecting a vehicle combination speed.

4. A system according to claim 1, wherein the detection means includes detecting at least one of the following driving conditions: ambient temperature, road inclination, vehicle combination weight, and vehicle combination speed.

5. A system according to claim 1, wherein the detection means further includes detection of auxiliary braking of the towing vehicle with a braking torque above a predefined limit.

6. A system according to claim 1, wherein the computing means receiving the detected signals determines if a critical driving condition is present and alerts the activation means.

7. A system according to claim 1, wherein the activation
means automatically activates the operation means.

8. A system according to claim 1, wherein the activation means includes an indicator and a driver operated activation switch for activating the operation means.

9. A system according to claim 8, wherein the indicator is an audio, visual or audiovisual indicator in a driver compartment of the towing vehicle.

10. A system according to claim 1, wherein the operating means automatically provides a series of short repeated trailer brake actuations when the trailer brake system is activated by the activation means.

11. A system according to claim 1, wherein the towed vehicle consists of a single trailer.

12. A system according to claim 1, wherein the
towed vehicle comprises a plurality of trailers.

13. A method of stabilising a vehicle combination of a towing vehicle and a towed vehicle, wherein a trailer brake system on the towed vehicle may be operated together with a vehicle brake system on the towing vehicle as well as independent from the vehicle brake system, the method including the steps of:
detecting at least one signal corresponding to at least one driving condition comprising a braking balance between the towing vehicle and the towed vehicle;
computing the at least one detected signal and comparing the at least one detected signal with a corresponding predetermined value representing a potentially critical driving condition;
allowing independent operation of the trailer brake system in response to a detected potentially critical driving condition; and
automatically operating the trailer brake system in response to the activation means by applying temporary braking actions on the towed vehicle so as to achieve a proactive stabilization of the vehicle combination.

14. A method according to claim 13, wherein the driving condition detection includes detecting a steering wheel angle.

15. A method according to claim 13, whereby wherein the driving condition detection includes detecting a vehicle combination speed.

16. A method according to claim 13, wherein the driving condition detection includes detecting one or more driving conditions selected from the group including: ambient temperature, road inclination, steering wheel angle, and vehicle combination weight.

17. A method according to claim 13, wherein the driving condition detection further includes detection of auxiliary braking of the tractor vehicle with a braking torque above a predefined limit.

18. A method according to claim 13, wherein the computing of the detected signals determines if a critical driving condition is present and alerts the activation means.

19. A method according to claim 13, wherein the independent operation of the trailer brake system is automatically activated in response to the detected critical driving condition.

20. A method according to claim 13, wherein the independent operation of the trailer brake system may be activated by a driver operated activation switch in response to an indicator triggered by the detected critical driving condition.

21. A method according to claim 20, wherein the indicator
is an audio, visual or audiovisual indicator in a driver compartment of the vehicle.

22. A method according to claim 13, wherein the independent operation of the trailer brake system automatically provides a series of short repeated trailer brake actuations when the trailer brake system is allowed activation.

23. A computer program comprising program code for carrying out all the steps in claim 13, when the program is executed by a computer.

24. A computer program product comprising program code, stored on a computer-readable medium, for carrying out the method in claim 13, when the program is executed by a computer.
